(19) United States
(12) Patent Application Publication
(10) Pub. No.: US 2004/0160331 A1
(43) Pub. Date: Aug. 19, 2004

(54) Cable structure having a wear detection function

(76) Inventor: Hung-Hsing Chiu, Taichung (TW)

Correspondence Address: Hung-Hsing Chiu, 58, MA YUAN WEST ST., TAICHUNG, TW

(21) Appl. No.: 10/370,321

(22) Filed: Feb. 13, 2003

(51) Int. Cl. G08B 21/00

(52) U.S. Cl. 340/673; 340/679

(57) ABSTRACT

A cable structure having a wear detection function includes an inner protective layer, an outer protective layer mounted on the inner protective layer, and a detection layer mounted between the inner protective layer and the outer protective layer. The detection layer includes two detection wires forming a complete circuit. Thus, when the outer protective layer of the cable structure is broken or worn out, the user can inspect the irregular condition of the cable structure immediately, thereby enhancing the safety of usage of the cable structure.

### BACKGROUND OF THE INVENTION

1. Field of the Invention

The present invention relates to a cable structure having a wear detection function, and more particularly to a cable structure having a wear detection function, wherein when the outer protective layer of the cable structure is broken or worn out, the user can inspect the irregular condition of the cable structure immediately, thereby enhancing the safety of usage of the cable structure.

2. Description of the Related Art

A conventional cable in accordance with the prior art comprises a plurality of conductive wires, an inner protective layer mounted on the conductive wires, and an outer protective layer mounted on the inner protective layer. However, when the protective layers of the cable are broken or worn out during a long-term utilization, the user cannot inspect the irregular condition of the cable immediately, so that the conductive wires are easily exposed to the ambient environment, thereby causing danger to the user.

### SUMMARY OF THE INVENTION

The present invention is to mitigate and/or obviate the disadvantage of the conventional cable.

The primary objective of the present invention is to provide a cable structure having a wear detection function, wherein when the outer protective layer of the cable structure is broken or worn out, the user can inspect the irregular condition of the cable structure immediately, thereby enhancing the safety of usage of the cable structure.

In accordance with the present invention, there is provided a cable structure having a wear detection function, comprising:

an inner protective layer;

an outer protective layer mounted on the inner protective layer; and

a detection layer mounted between the inner protective layer and the outer protective layer, wherein:

the detection layer includes two detection wires forming a complete circuit.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a cable structure having a wear detection function in accordance with the preferred embodiment of the present invention;

FIG. 1A is a partially enlarged view of the cable structure having a wear detection function as shown in FIG. 1;

FIG. 2 is a schematic view of a circuit of the cable structure having a wear detection function in accordance with the preferred embodiment of the present invention;

FIG. 3 is a schematic perspective view showing usage of the cable structure having a wear detection function in accordance with the preferred embodiment of the present invention;

FIG. 4 is a partially cut-away perspective view of the cable structure having a wear detection function in accordance with another embodiment of the present invention;

FIG. 5 is a partially cut-away perspective view of the cable structure having a wear detection function in accordance with another embodiment of the present invention; and

FIG. 5A is a partially enlarged view of the cable structure having a wear detection function as shown in FIG. 5.

### DETAILED DESCRIPTION OF THE INVENTION

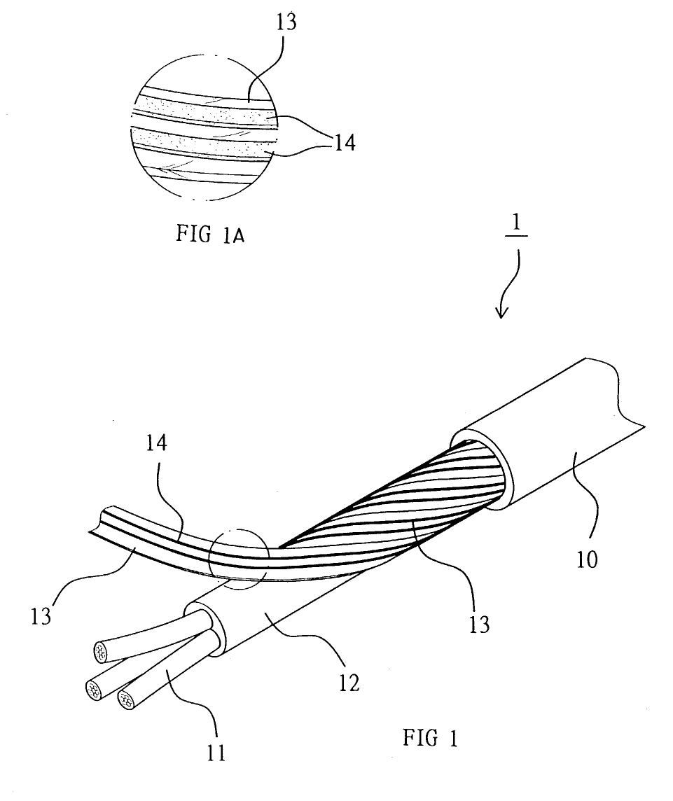

Referring to the drawings and initially to FIGS. 1-3, a cable structure 1 having a wear detection function in accordance with the preferred embodiment of the present invention comprises a plurality of conductive wires 11, an inner protective layer 12 mounted on the conductive wires 11, an outer protective layer 10 mounted on the inner protective layer 12, and a detection layer 13 mounted between the inner protective layer 12 and the outer protective layer 10. The inner protective layer 12 and the outer protective layer 10 are made of insulating material.

The detection layer 13 is coated on a periphery of the inner protective layer 12 in a helical manner, and the outer protective layer 10 is mounted on a periphery of the detection layer 13. The detection layer 13 includes two parallel detection wires 14.

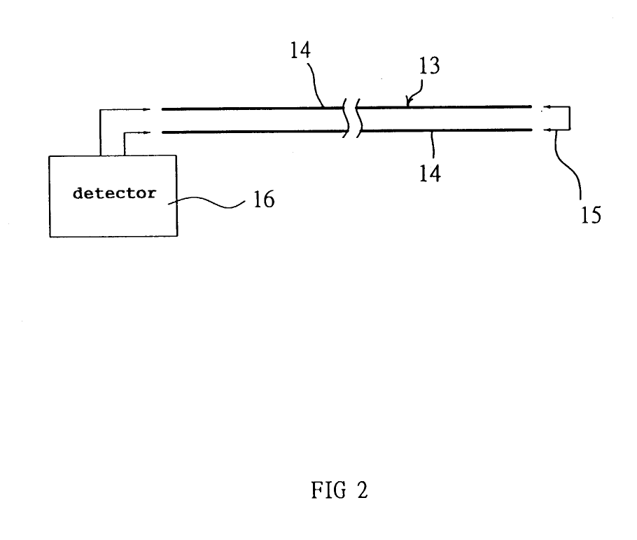

As shown in FIG. 2, the two detection wires 14 of the detection layer 13 are connected to a loop device 15 and a detector 16, thereby forming a complete circuit.

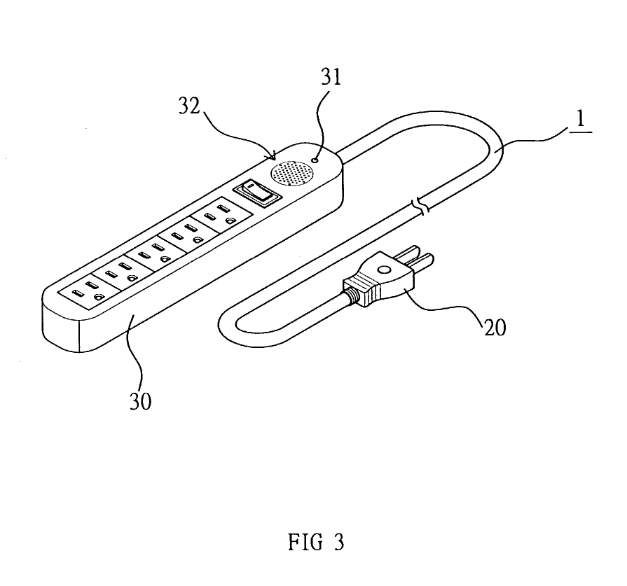

As shown in FIGS. 2 and 3, the cable structure 1 is used in an extension including a socket 30, a warning lamp 31, a buzzer 32, and a plug 20.

In practice, the two detection wires 14 of the detection layer 13 are connected to the plug 20 by the loop device 15, and the detector 16 is mounted in the socket 30 and connected to the warning lamp 31 and the buzzer 32, so that the two detection wires 14 of the detection layer 13 form a complete circuit. The impedance of the circuit can be predetermined by the length of the circuit. In such a manner, when the detection wires 14 of the detection layer 13 are worn out or broken, the circuit of the detection wires 14 of the detection layer 13 is broken or forms a short circuit, so that the impedance of the circuit is changed. Thus, the detector 16 can detect variation of the impedance of the circuit, and send a signal to the warning lamp 31 and the buzzer 32, so that the warning lamp 31 will light and the buzzer 32 will buzz, thereby providing a warning function so as to inform the user of the irregular condition of the circuit, so that the user can inspect that the cable structure 1 is worn out.

Accordingly, the detection layer 13 includes two detection wires 14 forming a complete circuit. Thus, when the outer protective layer 10 of the cable structure 1 is broken or worn out during a long-term utilization, the user can inspect the irregular condition of the cable structure 1 immediately and can replace the outer protective layer 10 of the cable structure 1, thereby preventing the conductive wires 11 from being exposed to the ambient environment, and thereby enhancing the safety of usage of the cable structure 1.

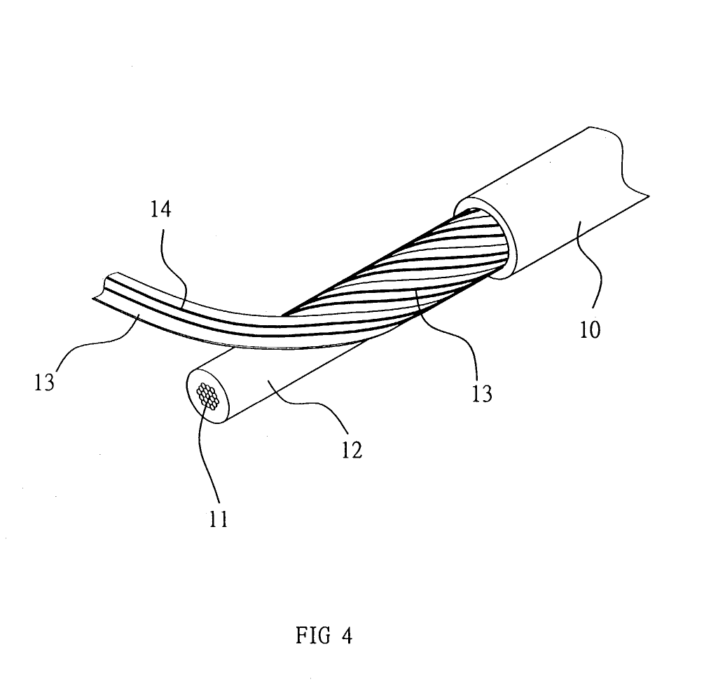

As shown in FIG. 4, the cable structure 1 comprises a single conductive wire 11.

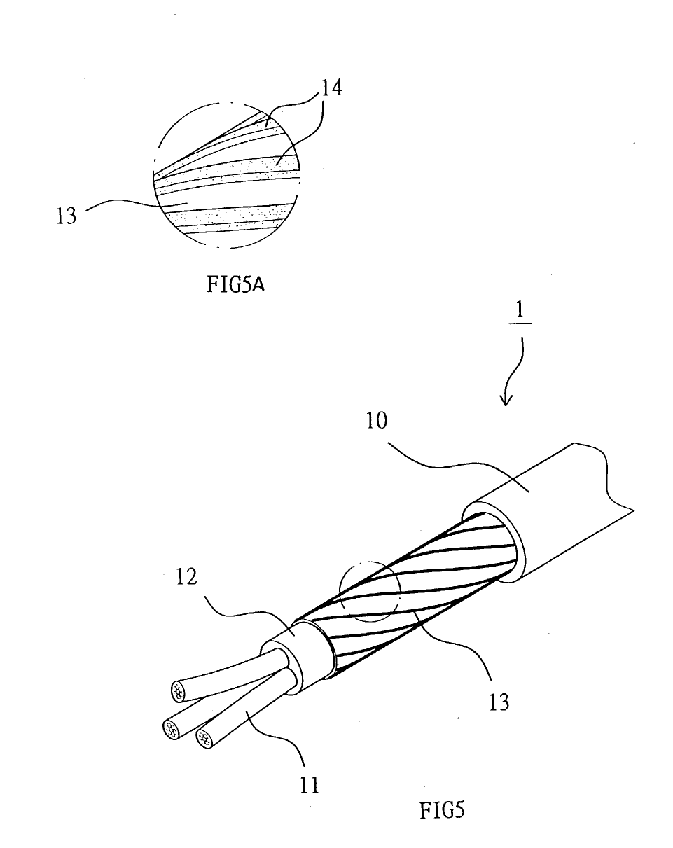

As shown in FIGS. 5 and 5A, the detection layer 13 is directly coated on the periphery of the inner protective layer 12.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A cable structure having a wear detection function, comprising:
an inner protective layer;
an outer protective layer mounted on the inner protective layer; and
a detection layer mounted between the inner protective layer and the outer protective layer, wherein:
the detection layer includes two detection wires forming a complete circuit.

2. The cable structure having a wear detection function in accordance with claim 1, wherein the detection layer is coated on a periphery of the inner protective layer in a helical manner.

3. The cable structure having a wear detection function in accordance with claim 1, wherein the detection layer is directly coated on a periphery of the inner protective layer.

4. The cable structure having a wear detection function in accordance with claim 1, wherein the outer protective layer is mounted on a periphery of the detection layer.

5. The cable structure having a wear detection function in accordance with claim 1, wherein the two detection wires of the detection layer are connected to a loop device and a detector, thereby forming the complete circuit.

6. The cable structure having a wear detection function in accordance with claim 5, wherein the cable structure is used in an extension including a socket, a warning lamp, a buzzer, and a plug, the two detection wires of the detection layer are connected to the plug by the loop device, and the detector is mounted in the socket and connected to the warning lamp and the buzzer, so that the two detection wires of the detection layer form the complete circuit.
